(19) United States
(12) Patent Application Publication
(10) Pub. No.: US 2012/0166885 A1
(43) Pub. Date: Jun. 28, 2012

(54) SYSTEM AND METHOD FOR TESTING HARD DISK DRIVE OF COMPUTING DEVICE

(75) Inventor: YAN-YAN ZHAN, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., New Taipei (TW)

(21) Appl. No.: 13/237,966

(22) Filed: Sep. 21, 2011

(30) Foreign Application Priority Data
Dec. 24, 2010 (CN) 201010604180.6

(51) Int. Cl. G06F 11/16

(52) U.S. Cl. 714/42; 714/E11.062

(57) ABSTRACT

A system and method test serial attached SCSI (SAS) hard disk drives (HDDs) of a computing device. The computing device includes a SAS backpanel, and the SAS backpanel includes one or more connectors that are respectively connected to the SAS HDDs. An identification (ID) of each of the connectors and an SCSI address of each of the SAS HDDs are obtained. A predefined file is created, and the obtained ID of each connector and the SCSI address of each SAS HDD are recorded into the predefined file. An SCSI address of a SAS HDD to be tested is obtained from the predefined file, and functions of the SAS HDD are tested. An ID of the connector connected to the SAS HDD is obtained from the predefined file, and is displayed on a display device if one or more of the functions are abnormal.

### BACKGROUND

1. Technical Field

Embodiments of the present disclosure relate generally to hard disk drive (HDD) testing technologies, and particularly to a system and method for testing HDDs of a computing device.

2. Description of Related Art

Many computing devices use a plurality of hard disk drives (HDDs) to provide large storage capacity for users. For example, in a storage server, a serial attached SCSI (SAS) backpanel is often installed to support multiple SAS HDDs. In testing the SAS HDDS, one or more SAS HDDs are connected to connectors of the SAS backpanel. If any of the SAS HDDs are malfunctioning, the test method only reveals that an SAS HDD is not working normally, and does not reveal which particular connector of the backpanel that the SAS HDD is connected.

### BRIEF DESCRIPTION OF THE DRAWINGS

FIG. 1 is a block diagram of one embodiment of a computing device including a hard disk drive (HDD) testing system.

FIG. 2 is a detailed block diagram of one embodiment of the HDD testing system of the computing device of FIG. 1.

FIG. 3 is a flowchart of one embodiment of a method for testing serial attached SCSI (SAS) HDDs of the computing device using the system of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

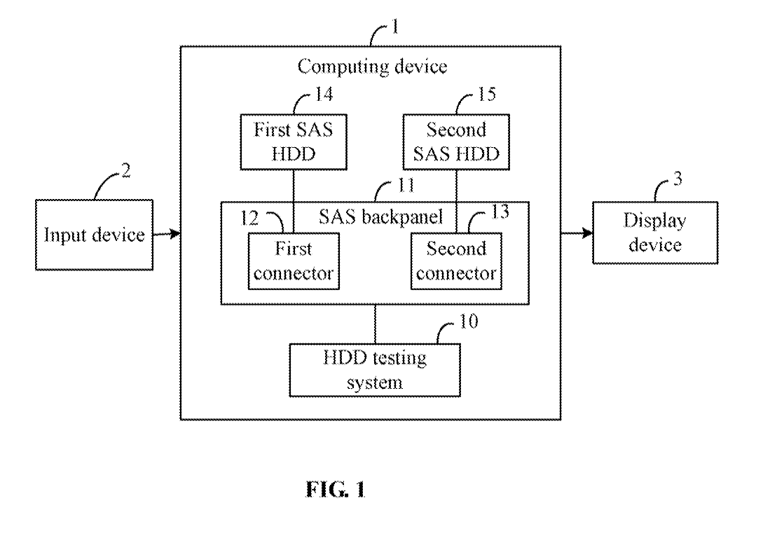

FIG. 1 is a block diagram of one embodiment of a computing device 1 including a hard disk drive (HDD) testing system 10. The computing device 1 is connected to an input device 2 such as a keyboard, and a display device 3 such as a display screen. In the embodiment, the computing device 1 further includes a serial attached SCSI (SAS) backpanel 11 and a plurality of SAS HDDS, such as a first SAS HDD 14 and a second SAS HDD 15. The SAS backpanel 11 includes a plurality of connectors, such as a first connector 12 and a second connector 13. The first SAS HDD 14 is connected to the first connector 12, and the second SAS HDD 15 is connected to the second connector 13. It is understood that FIG. 1 is only one example of the computing device 1 that can include more or fewer components than those shown in the embodiment, or a different configuration of the various components.

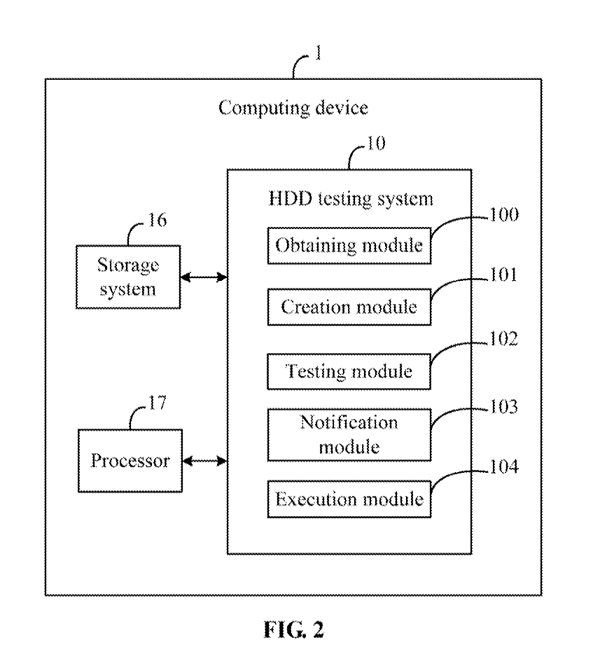

FIG. 2 is a detailed block diagram of one embodiment of the HDD testing system 10 of the computing device 1 of FIG. 1. In the embodiment, the HDD testing system 10 may include a plurality of software programs in the form of one or more computerized instructions stored in a storage system 16 of the computing device 1, and executed by a processor 17 of the computing device 1, to perform operations of the computing device 1. In the embodiment, the HDD testing system 10 includes an obtaining module 100, a creation module 101, a testing module 102, a notification module 103, and an execution module 104. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The obtaining module 100 is operable to obtain an identification (ID) of each of the connectors, and an SCSI address of each of the SAS HDDs of the computing device 1. In the embodiment, each of the connectors has a predetermined ID. For example, the ID of the first connector 12 can be “J1”, and the ID of the second connector 13 can be “J2”. Each ID of the connectors may be printed on the surface of the backpanel 11. The SCSI address of each connector may be pre-allocated by a device driver that is installed in an operating system of the computing device 1. For example, the SCSI address of the first SAS HDD 14 can be SCSI (0x1, 0x0), and the SCSI address of the second SAS HDD 15 can be SCSI (0x2, 0x0).

The creation module 101 is operable to create a predefined file in the storage system 16, and record the ID of each of the connectors and the SCSI address of each of the SAS HDDs into the predefined file, wherein the ID of each connector corresponds to an SCSI address of an SAS HDD. In the embodiment, the predefined file may be a special format file, such as an initialization (INI) file.

The testing module 102 is operable to obtain an SCSI address of an SAS HDD to be tested from the predefined file, and detect whether the SAS HDD is connected to one of the connectors corresponding to the obtained SCSI address.

The notification module 103 is operable to generate a first message indicating that the SAS HDD needs to be connected to the connector, if there is no connector connected to the SAS HDD to be tested. In one embodiment, the first message may be an audio file that can be played, or a text file that can be displayed on the display device 3.

The testing module 102 is further operable to test whether functions of the SAS HDD to be tested are normal, if there is a connector connected to the SAS HDD. In the embodiment, the functions of the SAS HDD include a disk partitioning function, and a data reading and writing function. If the functions of the SAS HDD are normal (e.g., operating according to manufacturing requirements), the notification module 103 generates a second message indicating that the SAS HDD works normally.

The execution module 104 is operable to obtain an ID of the connector connected to the SAS HDD from the predefined file according to the obtained SCSI address of the SAS HDD if the functions of the SAS HDD is abnormal, and display the obtained ID on the display device 3. For example, if the SCSI address of the SAS HDD is (0x2, 0x0), the ID of the second connector (e.g., “J2”) is obtained from the predefined file, and the execution module 104 displays the ID of the second connector 13 on the display device 3.

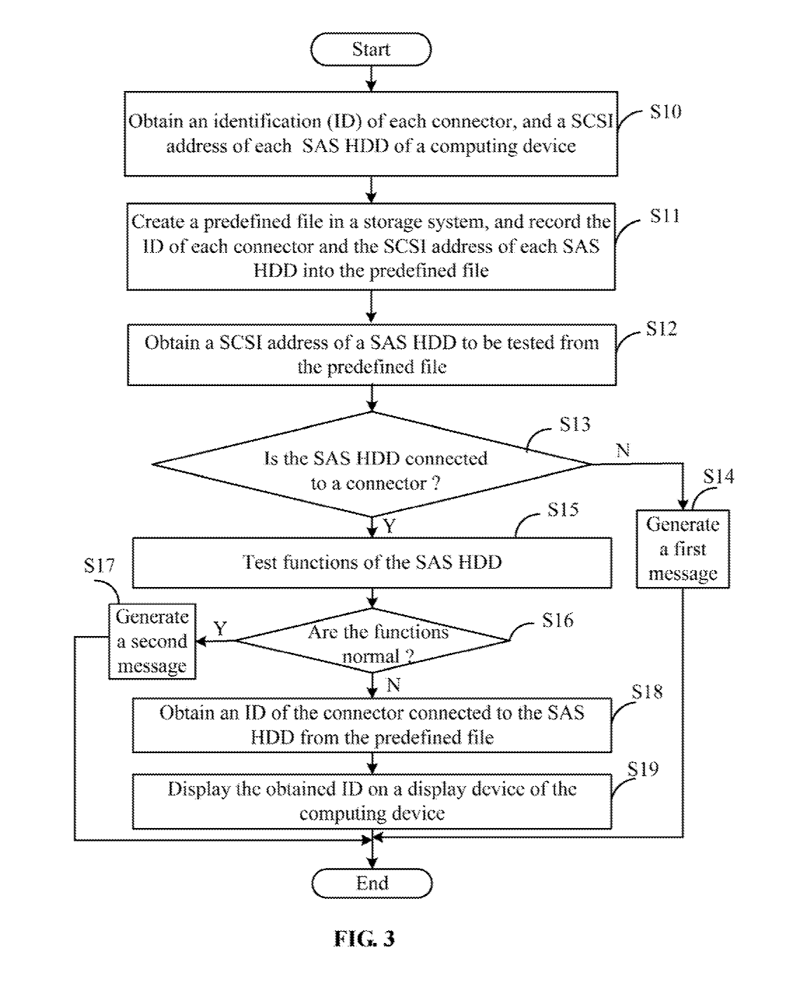

FIG. 3 is a flowchart of one embodiment of a method for testing SAS HDDs of the computing device 1 using the system 10 of FIG. 1. Depending on the embodiment, additional blocks may be added, others removed, and the ordering of the blocks may be changed.

In block S10, the obtaining module 100 obtains an identification (ID) of each of the connectors, and an SCSI address of each of the SAS HDDS of the computing device 1. In the embodiment, each of the connectors has a predetermined ID. The SCSI address of each connector may be pre-allocated by a device driver that is installed in an operating system of the computing device 1.

In block S11, the creation module 101 creates a predefined file in the storage system 16, and records the ID of each of the connectors and the SCSI address of each of the SAS HDDs into the predefined file, wherein the ID of each connector corresponds to an SCSI address of an SAS HDD. In the embodiment, the predefined file may be a special format file, such as an INI file.

In block S12, the testing module 102 obtains an SCSI address of a SAS HDD to be tested from the predefined file.

In block S13, the testing module 102 detects whether the SAS HDD is connected to a connector of the SAS backpanel 11. If the SAS HDD is not connected to a connector, in block S14, the notification module 103 generates a first message indicating that the SAS HDD needs to be connected to one of the connectors, and ends the procedure. If the SAS HDD is connected to a connector, block S15 is implemented.

In block S15, the testing module 102 tests functions of the connected SAS HDD. In the embodiment, the functions of the SAS HDD include a disk partitioning function, and a data reading and writing function.

In block S16, the testing module 102 determines whether the functions of the SAS HDD are normal. If the functions of the SAS HDD are normal, in block S17, the notification module 103 generates a second message indicating that the SAS HDD works normally, and ends the procedure. If one or more of the functions of the SAS HDD are abnormal, block S18 is implemented.

In block S18, the execution module 104 obtains an ID of the connector connected to the SAS HDD from the predefined file according to the obtained SCSI address of the SAS HDD. In block S19, the execution module 104 displays the obtained ID on the display device 3.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method for testing serial attached SCSI (SAS) hard disk drives (HDDs) of a computing device, the computing device comprising a SAS backpanel, the SAS backpanel comprising a plurality of connectors that are respectively connected to the SAS HDDs, the method comprising:
obtaining an identification (ID) of each of the connectors, and an SCSI address of each of the SAS HDDs;
creating a predefined file in a storage system of the computing device, and recording the ID of each of the connectors and the SCSI address of each of the SAS HDDs into the predefined file, wherein the ID of each connector corresponds to an SCSI address of a SAS HDD;
obtaining an SCSI address of a SAS HDD to be tested from the predefined file, and detecting whether the SAS HDD is connected to a connector of the SAS backpanel;
testing whether functions of the SAS HDD are normal if the SAS HDD is connected to a connector; and
obtaining an ID of the connector connected to the SAS HDD from the predefined file according to the obtained SCSI address of the SAS HDD if one or more of the functions are abnormal, and displaying the obtained ID on a display device of the computing device.

2. The method according to claim 1, further comprising:
generating a first message indicating that the SAS HDD needs to be connected to one of the connectors, if the SAS HDD is not connected to a connector.

3. The method according to claim 1, wherein the functions of the SAS HDD comprise a disk partitioning function, and a data reading and writing function.

4. The method according to claim 1, further comprising:
generating a second message indicating that the SAS HDD works normally, if the functions of the SAS HDD are normal.

5. The method according to claim 1, wherein the ID of each of the connectors is printed on a surface of the SAS backpanel.

6. The method according to claim 1, wherein the SCSI address of each of connectors is pre-allocated by a device driver that is installed in an operating system of the computing device.

7. A computing device, comprising:
a plurality of hard disk drives (HDDs);
a SAS backpanel comprising a plurality of connectors that are respectively connected to the HDDs;
one or more programs stored in a storage system and being executable by at least one processor of the computing device, the one or more programs comprising:
an obtaining module operable to obtain an identification (ID) of each of the connectors, and an SCSI address of each of the SAS HDDs;
a creation module operable to create a predefined file in the storage system, and record the ID of each of the connectors and the SCSI address of each of the SAS HDDs into the predefined file, wherein the ID of each connector corresponds to an SCSI address of a SAS HDD;
a testing module operable to obtain an SCSI address of a SAS HDD to be tested from the predefined file, detect whether the SAS HDD is connected to a connector of the SAS backpanel, and test whether functions of the SAS HDD are normal if the SAS HDD is connected to a connector; and
an execution module operable to obtain an ID of the connector connected to the SAS HDD from the predefined file according to the obtained SCSI address of the SAS HDD if one or more of the functions are abnormal, and display the obtained ID on a display device of the computing device.

8. The computing device according to claim 7, wherein the one or more programs further comprise:
a notification module operable to generate a first message indicating that the SAS HDD needs to be connected to one of the connectors, if the SAS HDD is not connected to a connector.

9. The computing device according to claim 8, wherein the notification module further operable to generate a second message indicating that the SAS HDD works normally, if the functions of the SAS HDD are normal.

10. The computing device according to claim 7, wherein the functions of the SAS HDD comprise a disk partitioning function, and a data reading and writing function.

11. The computing device according to claim 7, wherein the ID of each of the connectors is printed on a surface of the SAS backpanel.

12. The computing device according to claim 7, wherein the SCSI address of each of connectors is pre-allocated by a device driver that is installed in an operating system of the computing device.

13. A non-transitory storage medium storing a set of instructions, the set of instructions capable of being executed by a processor of a computing device, cause the computing device to perform a method for testing serial attached SCSI (SAS) hard disk drives (HDDs), the computing device comprising a SAS backpanel, the SAS backpanel comprising a plurality of connectors that are respectively connected to the SAS HDDs, the method comprising:
obtaining an identification (ID) of each of the connectors, and an SCSI address of each of the SAS HDDs;
creating a predefined file in a storage system of the computing device, and recording the ID of each of the connectors and the SCSI address of each of the SAS HDDs into the predefined file, wherein the ID of each connector corresponds to an SCSI address of a SAS HDD;
obtaining an SCSI address of a SAS HDD to be tested from the predefined file, and detecting whether the SAS HDD is connected to a connector of the SAS backpanel;
testing whether functions of the SAS HDD are normal if the SAS HDD is connected to a connector; and
obtaining an ID of the connector connected to the SAS HDD from the predefined file according to the obtained SCSI address of the SAS HDD if one or more of the functions are abnormal, and displaying the obtained ID on a display device of the computing device.

14. The non-transitory storage medium according to claim 13, wherein the method further comprises:
generating a first message indicating that the SAS HDD needs to be connected to one of the connectors, if the SAS HDD is not connected to a connector.

15. The non-transitory storage medium according to claim 13, wherein the functions of the SAS HDD comprise a disk partitioning function, and a data reading and writing function.

16. The non-transitory storage medium according to claim 13, wherein the method further comprises:
generating a second message indicating that the SAS HDD works normally, if the functions of the SAS HDD are normal.

17. The non-transitory storage medium according to claim 13, wherein the ID of each of the connectors is printed on a surface of the SAS backpanel.

18. The non-transitory storage medium according to claim 13, wherein the SCSI address of each of connectors is pre-allocated by a device driver that is installed in an operating system of the computing device.
